(19) United States
(12) Patent Application Publication
(10) Pub. No.: US 2013/0067401 A1
(43) Pub. Date: Mar. 14, 2013

(54) CONTEXT SENSITIVE EXTENSIONS FOR EXISTING APPLICATIONS

(71) Applicant: Markus Koenigstein, Bad Schoenborn (DE)

(72) Inventor: Markus Koenigstein, Bad Schoenborn (DE)

(73) Assignee: SAP AG, Walldorf (DE)

(21) Appl. No.: 13/228,883

(22) Filed: Sep. 9, 2011

(51) Int. Cl. G06F 3/048

(52) U.S. Cl. 715/804

(57) ABSTRACT

A side panel application includes a user interface that is simultaneously displayed on a computer screen alongside the user interface for an application of an existing Enterprise Resource Planning (ERP) system. The side panel application can add context sensitive extensions to the ERP system application which allow for the integration of additional functionality into the ERP system. The ERP system application displays content on the computer screen and certain on-screen content is transferred to the side panel application. A content display application running within the side panel application reads additional content from the ERP system based on the transferred contents and displays information that is context sensitive, i.e. based on the transferred or read content, in the side panel application user interface.

### BACKGROUND

Many businesses rely on enterprise resource planning (ERP) computing architectures, including legacy systems, to electronically manage and coordinate business resources, information, and functions. In large organizations these computing architectures may be made up of hundreds of systems, distributed across the various entities making up the organization. For example, a global business may rely on location-specific logistics systems to process orders in different localities, division-specific supply chain management systems to manage supply chains across geographies, and business specific accounting systems to manage financial transactions at a business level.

Over time these different systems in the organization may need to be modified or upgraded in order to benefit from new developments in ERP systems. However, modifying or upgrading a large number of systems can not be done quickly and furthermore many users may not want to modify or upgrade their systems and would therefore be excluded from any new developments in ERP systems. Even software developers may feel the need to add new features to older ERP systems without having to go through the costly and complicated process of developing new upgrades to these older systems.

Thus, there is a need to quickly and efficiently integrate features from newer ERP systems into older systems without having to modify or upgrade the older systems.

### SUMMARY OF THE INVENTION

An existing ERP system can benefit from a side panel application running in a separate content system with a user interface that is simultaneously displayed on a computer screen (or other suitable display) alongside the user interface for an application of the existing ERP system. The side panel application can be used to add context sensitive extensions to the existing ERP system application which allow for the integration of additional functionality into the existing ERP system application. The ERP system does not have to be touched for this purpose, instead a content system (e.g. hub) may be used which stores the side panel application and side panel application content/data.

An ERP system application may display certain information regarding a business transaction on a computer screen (or other suitable display), the contents of certain on screen fields of the system application (e.g. customer name) are extracted and transferred to the side panel application of the content system. A content display application running within the side panel application may read additional content (e.g. address of the customer) from the existing system based on the extracted contents and then display the read contents in a content display application user interface within the side panel application user interface displayed on the computer screen in a “side panel” section on the computer screen. In this way, the side panel is able to display information that is context sensitive, i.e. based on the content of at least one of the on screen fields of the ERP system application.

### BRIEF DESCRIPTION OF THE DRAWINGS

FIG. 1 shows an exemplary system according to the present invention.

FIG. 2 shows an exemplary method according to the present invention.

FIG. 3 shows a screenshot of a user interface of an existing system application.

FIG. 4 shows a screenshot of a user interface of an existing system application.

FIG. 5 shows a screenshot of a user interface of an existing system application and an exemplary embodiment of a user interface of a side panel application according to the present invention.

FIG. 6 shows a screenshot of a user interface of an existing system application and an exemplary embodiment of a user interface of a side panel application according to the present invention.

FIG. 7 shows a screenshot of a user interface of an existing system application launched via a side panel application according to the present invention.

FIG. 8 shows a screenshot of a user interface of an existing system application.

FIG. 9 shows a screenshot of a user interface of an existing system application.

FIG. 10 shows a screenshot of a user interface of an existing system application and an exemplary embodiment of a user interface of a side panel application according to the present invention.

FIG. 11 shows a screenshot of a user interface of an existing system application and an exemplary embodiment of a user interface of a side panel application according to the present invention and a screenshot of a user interface of a web browsing application launched via the side panel application.

FIG. 12 shows a screenshot of a user interface of an existing system application and an exemplary embodiment of a user interface of a side panel application according to the present invention.

FIG. 13 shows a screenshot of a user interface of an existing system application and an exemplary embodiment of a user interface of a side panel application according to the present invention.

FIG. 14 shows a screenshot of a user interface of an exemplary embodiment of a collaboration application launched via a side panel application according to the present invention.

### DETAILED DESCRIPTION

Embodiments of the present invention will now be described in detail, by way of example only, with reference to the accompanying drawings in which identical or corresponding parts/features are provided with the same reference numerals in the figures.

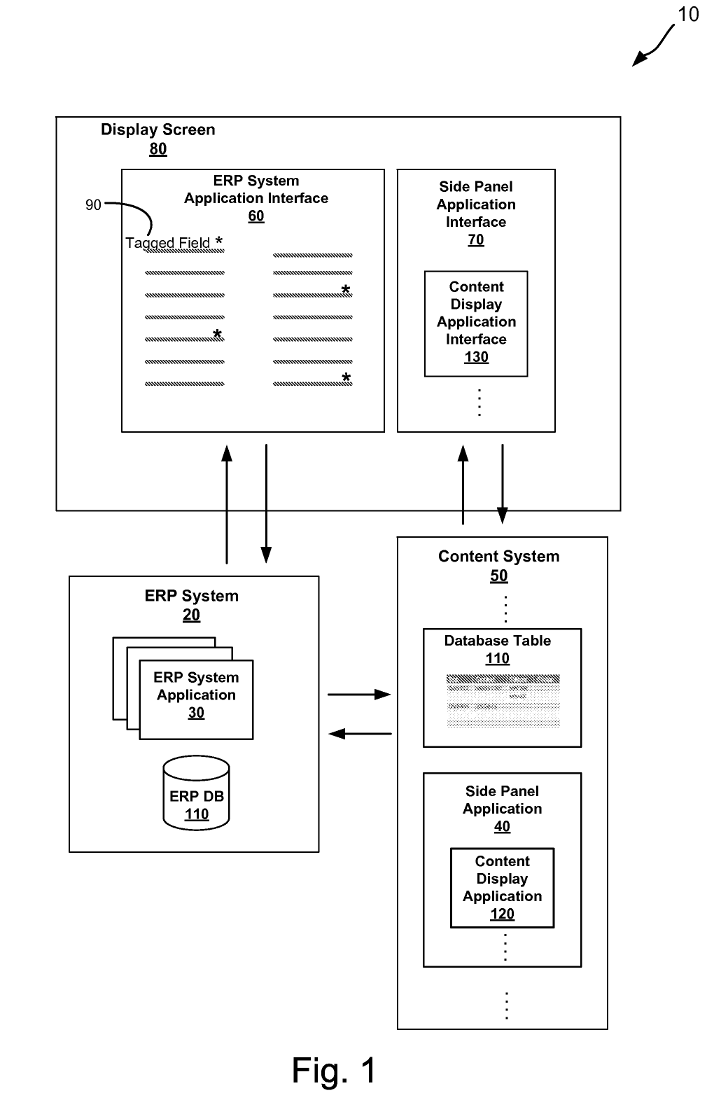

FIG. 1 shows an exemplary embodiment of a composite system 10 which an organization may use for enhancing existing systems, such as existing ERP system 20, in order to take advantage of new developments in ERP systems without having to invest in costly and time consuming upgrades of complex legacy systems. The composite system may be configured to provide additional information and/or functionality to the user of a specific ERP system application 30 of the existing ERP system 20 by adding context sensitive extensions via a side panel application 40. The existing ERP system 20 does not have to be touched for this purpose, instead a content system 50 can be used to run the side panel application 40 and store the side panel content and side panel data. The information regarding which side panel application(s) 40 will be running together with ERP system application 30 may be stored in the content system. The ERP system application interface 60 and the side panel application interface 70 may be simultaneously displayed side by side on a display screen providing a “split” display screen 80. ERP system application interface 60 may include several “tagged” fields 90 the contents of which are extracted from the ERP system 20, for example from an ERP database 100, into the side panel application 40 of content system 50. A database table 110 stored in content system 50 may be provided, for example by the Net Weaver Business Client (NWBC), for maintaining “tagging” information regarding which fields of ERP system application interface 60 include contents that will be extracted, i.e. which fields are tagged fields 90. This tagging information may be transferred from the content system 50 to the ERP system 20 at runtime, for example via an API provided by NWBC.

Furthermore the side panel application may include user selectable content display applications 120 which may read additional content information from ERP system 20 and then display at least one of the read contents of ERP system 20 in a content display user interface 130 within the side panel application interface 70. The information regarding which content display application(s) 120 will be running in the side panel application 40 may be stored in the content system. Content display applications 120 may read the additional content information from the ERP system 20 based on the extracted contents of tagged fields 90. In this way, content display user interface 130 within the side panel application interface 70 is able to display information that is context sensitive, i.e. based on the content of at least one of the on screen fields of the ERP system application 30. In one example embodiment of the system according to the present invention, the existing ERP system and the content system may be one system if the existing ERP system is upgraded to include the features/functionality of the content system.

The content display applications 120 for the side panel application 40 may be built in such a way that they can react to unforeseen situations. Such unforeseen situations might be e.g. the following: a) if an object is not recognized immediately; content display applications 120 must handle this situation and display a message that the required functionality is currently not available; or b) the user of an applications navigates to a different screen of an existing ERP system application or to a different ERP system application (in-place navigation) which does not have a corresponding side panel application or does not include the same content display applications 120 displayed for the original existing ERP system application 30; here it is also required that the user be informed that at least some of the functionality of the side panel application 40 is not available in the current context.

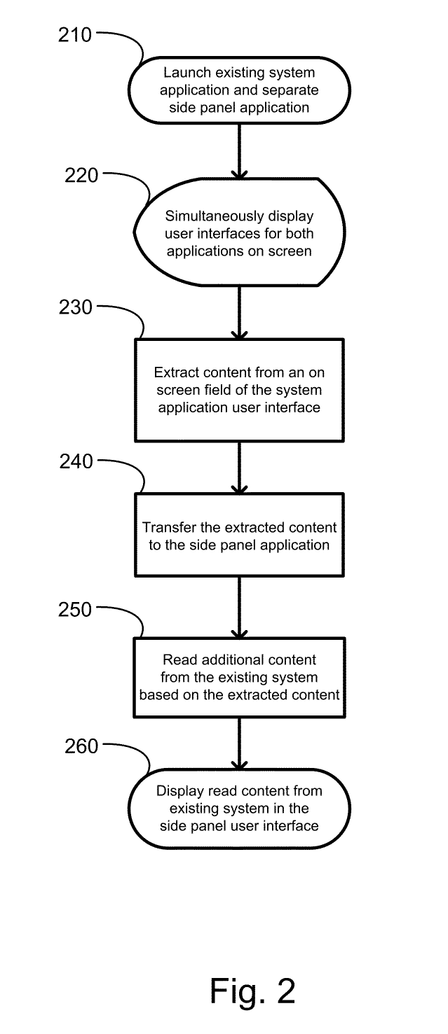

FIG. 2 shows an exemplary embodiment of a method in which both an application of an existing system and a side panel application of a separate content system may be launched in step 210. The respective user interfaces for the existing system application and the side panel application may be simultaneously displayed on a computer screen in step 220. The respective user interfaces may be displayed in a side by side manner on the computer screen. In step 230 the contents of at least one “tagged” on screen field of the existing system application user interface may be extracted from the existing system according to a data base table that stores the “tagging” information in the content system. The extracted contents of the at least one on screen field of the existing system application user interface may then be transferred to the side panel application of the content system in step 240. A user selectable content display application running within the side panel application may then read additional content from the existing system based on the extracted contents in step 250. In step 260 the at least one user selectable content display application may display at least one of the read contents of the existing system application in at least one content display application user interface within the side panel application user interface displayed on the computer screen.

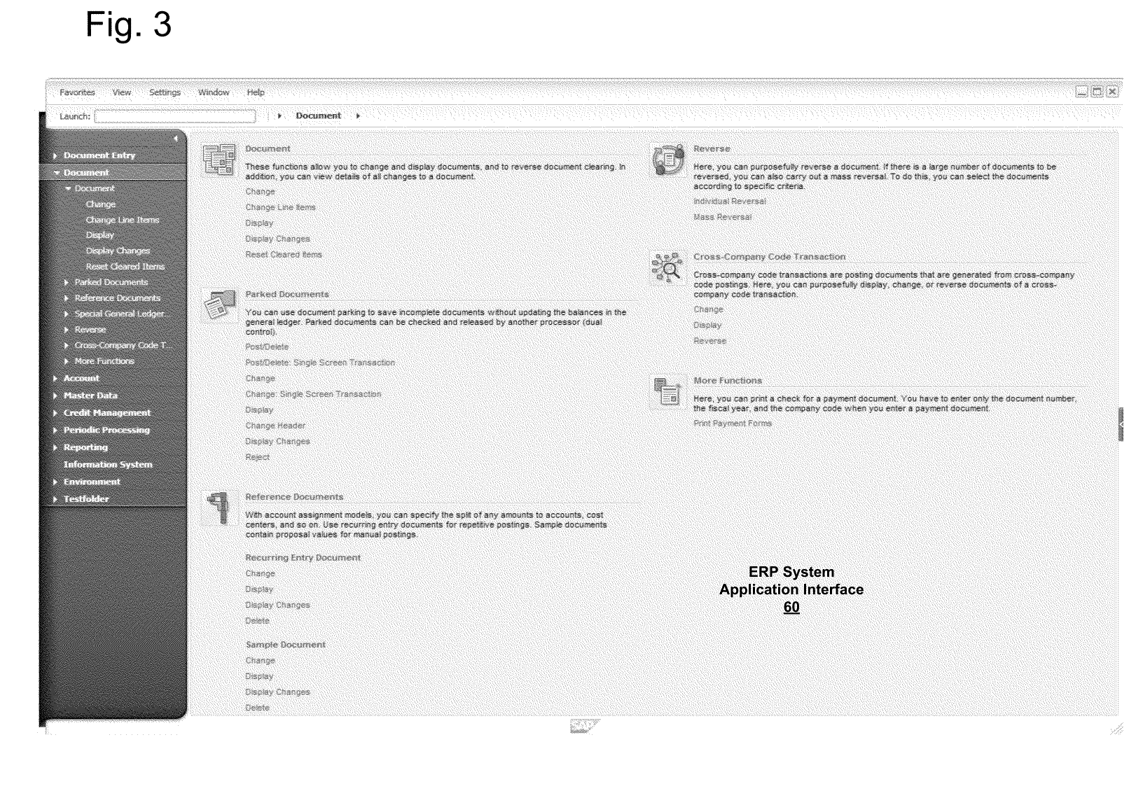

FIG. 3 shows a screenshot of an exemplary embodiment of an ERP system application interface 60 in which the user has selected the Document functionality (highlighted in the drop down list on the left hand side of the screenshot) for changing and displaying documents in an ERP system application 30.

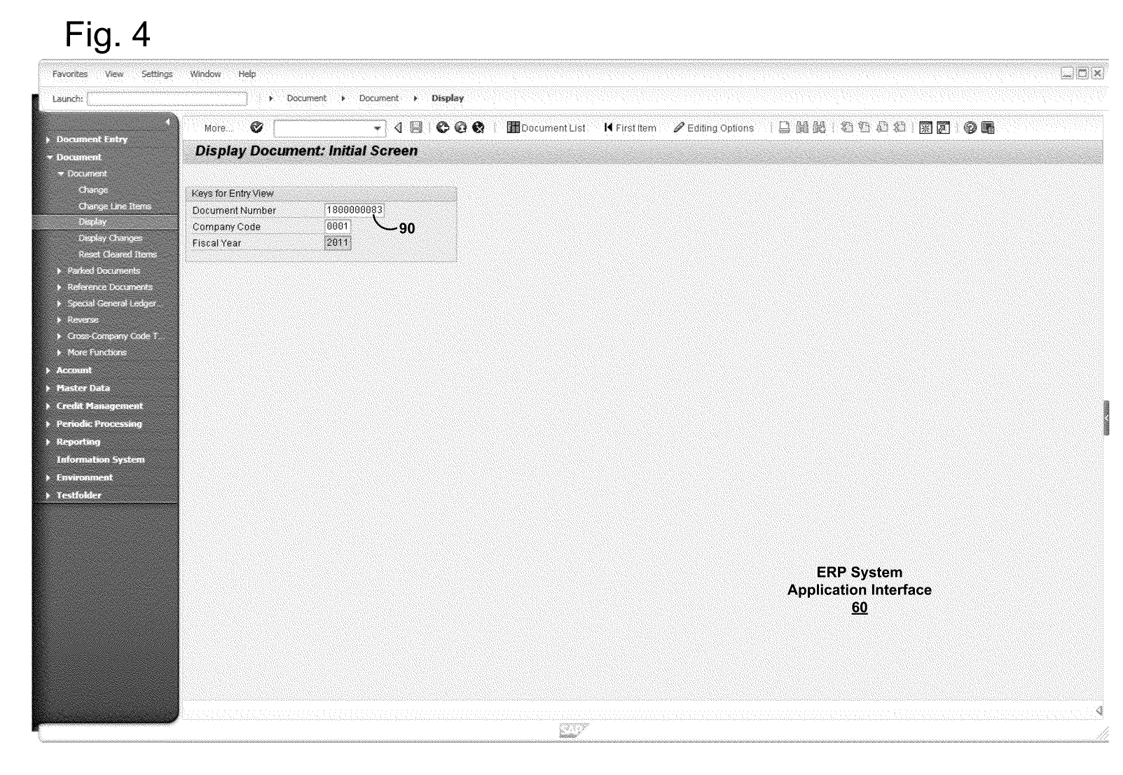

FIG. 4 shows another screenshot of an exemplary embodiment of an ERP system application interface 60 in which the user has selected the Display functionality (highlighted in the drop down list on the left hand side of the screenshot) for displaying documents in the ERP system application 30 and selected document number 1800000083 in the Document Number field for viewing. In this example the Document Number field of the ERP system application interface 60 is a tagged field 90, the contents of which are extracted to the side panel application.

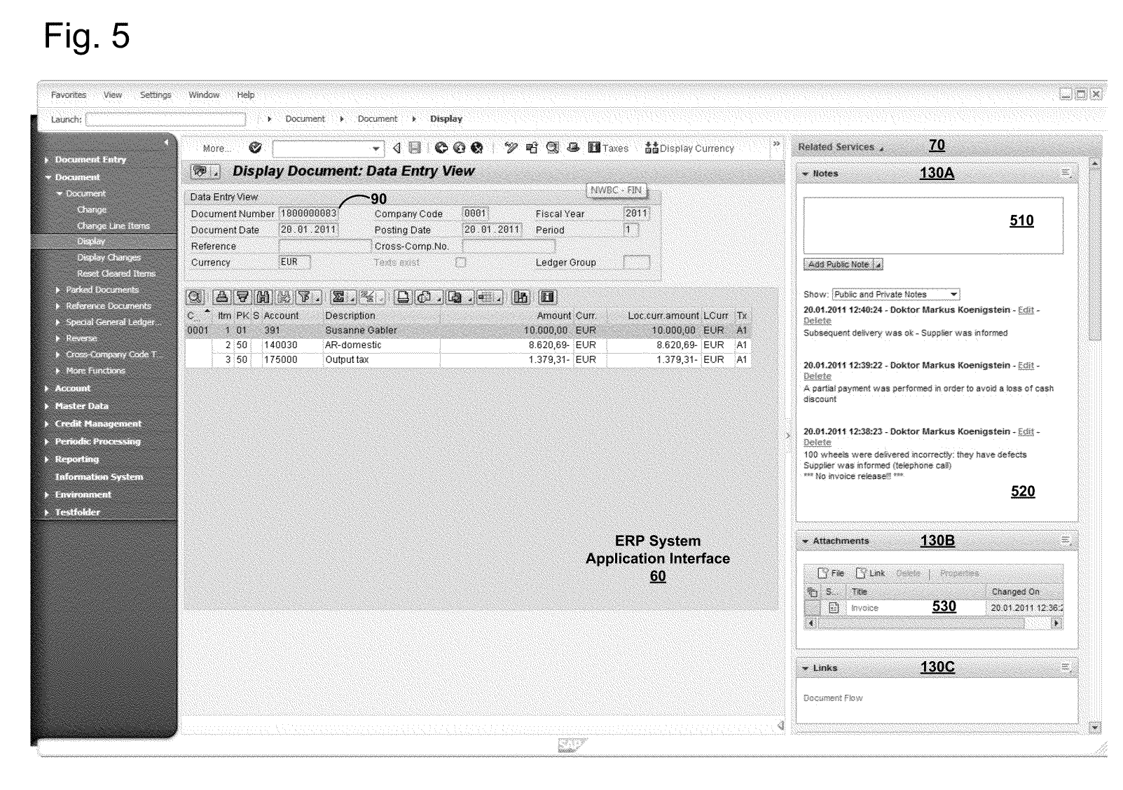

FIG. 5 shows a screenshot of an exemplary embodiment of an ERP system application interface 60 with information and functionality regarding document number 1800000083 being displayed in a side by side arrangement with an exemplary embodiment of a side panel application interface 70 for adding “Related Services” functionality to the ERP system application 30. As mentioned above, the Document Number field of the ERP system application interface 60 is a tagged field 90, the contents of which are extracted to the side panel application. In an example embodiment of the present invention the user may select which side panel application 40 will be running in conjunction with ERP system application 30 and the side panel application interface 70 shown side by side with the ERP system application interface 60 will correspond to this choice. The side panel application interface 70 includes several content display application interfaces 130A-130C which correspond to respective content display applications 120 which may be running in the side panel application 40. In an example embodiment of the present invention the user may select which content display applications 120 will or will not be running in the side panel application 40 and the content display application interfaces 130 shown in the side panel application interface 70 will correspond to these choices.

For example, content display application interface 130A corresponds to a content display application 120 for providing a “Notes” functionality to ERP system application 30. Within content display application interface 130A the user is provided with functionality for adding notes to the currently selected document in field 510 of content display application interface 130A. The notes may be provided as objects in content system 50 which are associated with document 1800000083 of ERP system 20. The notes may be created according to filters selected by the user, for example, functionality for creating public or private notes is shown in field 510. Also within content display application interface 130A, the user is provided with a field 520 for viewing any existing notes already associated with the currently selected document. The notes may be viewed according to filters selected by the user, for example, both public and private notes are being shown in field 520. In an example embodiment of the present invention the user may select which information or functionality is provided by a content display application 120 and also in what format the information or functionality is displayed, for example, the particular content display application 120 for providing a “Notes” functionality may include only the ability to view existing notes or the displayed notes may not be able to be edited or deleted and the content display application interface 130A shown in the side panel application interface 70 will correspond to these choices.

Content display application interface 130B corresponds to a content display application 120 for providing an “Attachments” functionality to ERP system application 30. Within content display application interface 130B the user is provided with functionality for linking other documents in ERP system 20 or new documents created by the user in the content system to the currently viewed document 1800000083. Documents which have already been linked to the currently viewed document may be viewed according to filters selected by the user, for example, according to the title or the last date of a change to the document as shown in field 530 of content display application interface 130B. The information regarding which documents of ERP system 20 are so linked may be stored in content system 50 or may be read from ERP system 20.

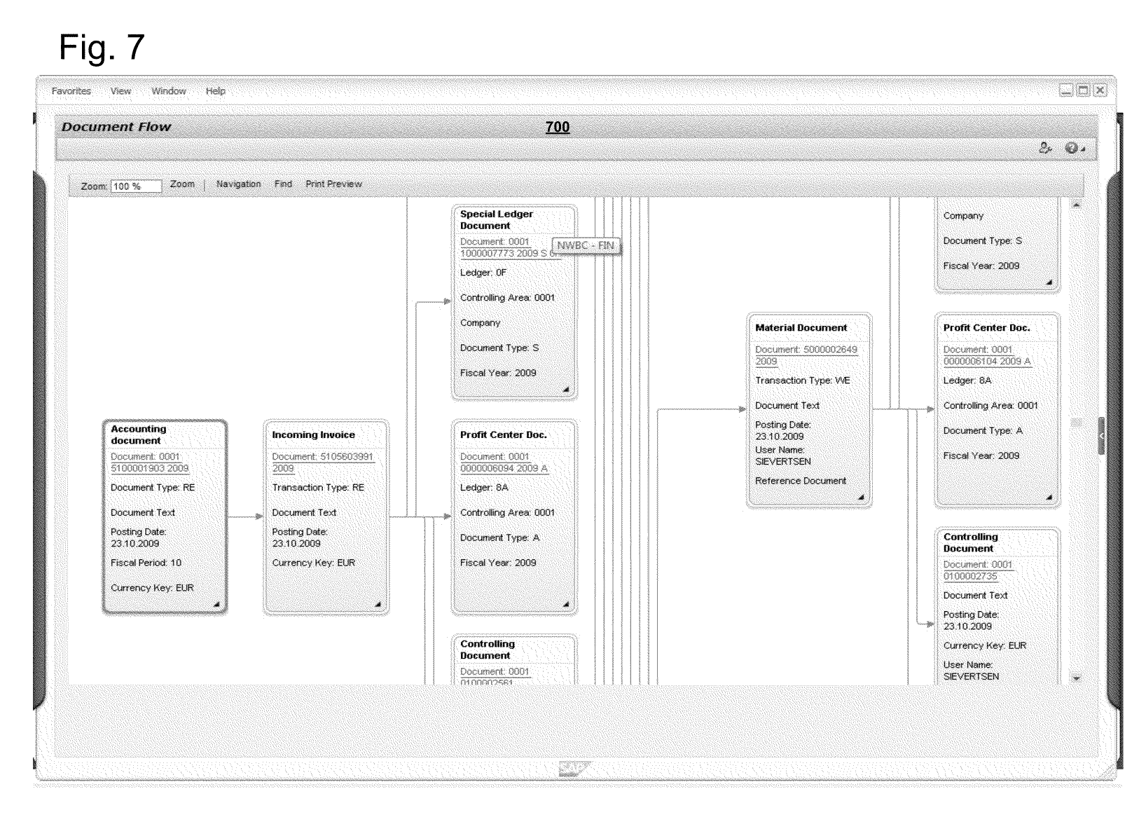

Content display application interface 130C corresponds to a content display application 120 for providing a “Links” functionality to ERP system application 30. Within content display application interface 130C the user is provided with functionality for launching other applications parameterized with information related to the currently viewed document 1800000083. The applications may be ERP system applications or other applications in the content system. For example, a link to a “Document Flow” application of ERP system 20 is shown that may be launched in order to view the history of the currently viewed document. The process of launching the parameterized application, which may be launched in a separate window on the display screen 80, is performed by the side panel application 40 in content system 50. FIG. 7 shows an exemplary embodiment of a user interface 700 for the Document Flow application launched in a new window on the display screen 80. The Document Flow application is already displaying the information for the document currently being viewed in the ERP system application 30 without further input from the user.

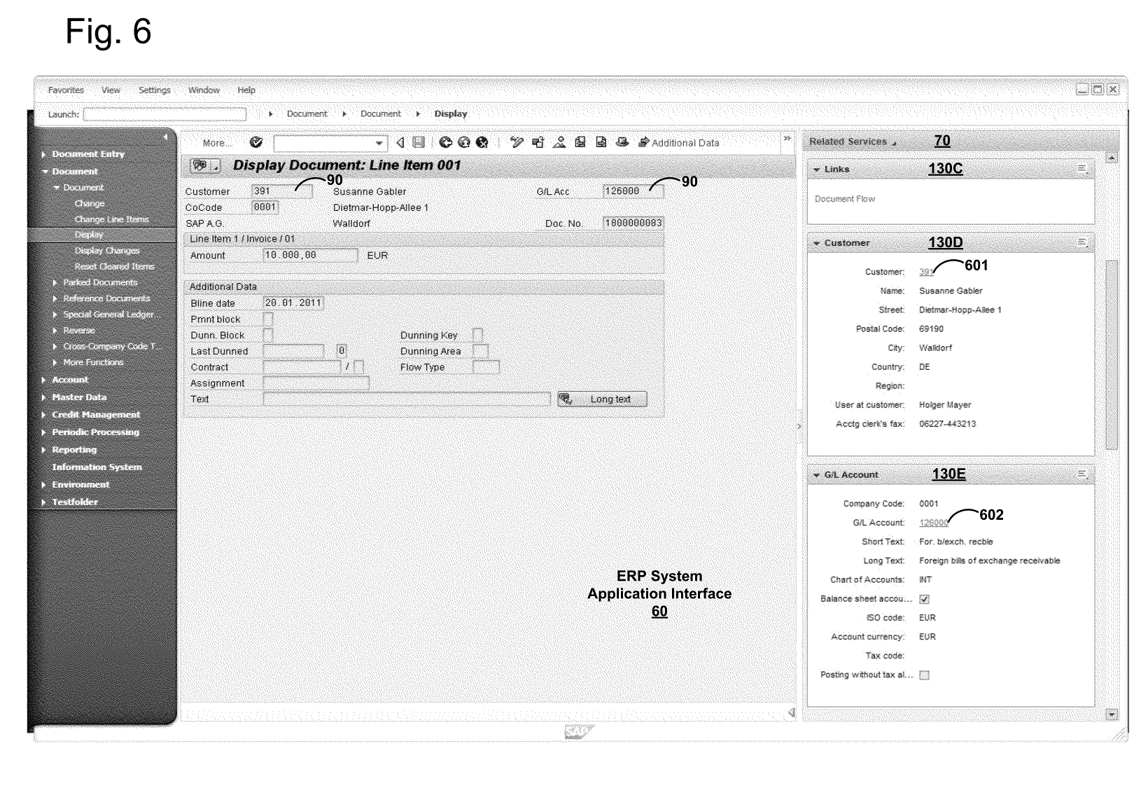

The screenshot shown in FIG. 5 also shows that the user has selected line Item 1 related to customer “Susanne Gabler” in the ERP system application interface 60 (highlighted in the list in the center of the screenshot) for further viewing. FIG. 6 shows a screenshot of an exemplary embodiment of an ERP system application interface 60 with information and functionality regarding the selected customer of line Item 1. In this example the Customer and G/L Accounts fields of the ERP system application interface 60 are the tagged fields 90, the contents of which are extracted to the side panel application. Furthermore, as indicated by the scroll bar on the right side of the screenshot, the user has scrolled down the side panel application interface 70 for “Related Services” to display further content display application interfaces 130D and 130E which also correspond to respective content display applications 120 which may be included in a side panel application 40.

Content display application interface 130D corresponds to a content display application 120 for providing an increased “Customer” functionality to ERP system application 30. Within content display application interface 130D the user is provided with additional data regarding the selected customer. This additional data would not ordinarily be available without having to access other screens of ERP system application 30. As mentioned previously, the user can preselect which additional information about the selected customer will be displayed in content display application interface 130D. The additional information about the selected customer may be read from ERP system 20. In an example embodiment, content display application interface 130D may include a link 601 that can launch an application in the ERP system for accessing even more information about the selected customer (e.g. customer master data). The process of launching the parameterized ERP system application, which may be launched in a separate window on the display screen 80, is performed by the side panel application 40 in content system 50.

Content display application interface 130E corresponds to a content display application 120 for providing an increased “G/L Account” functionality to ERP system application 30. Within content display application interface 130E the user is provided with additional data regarding the general ledger account for the selected customer. This additional data would not ordinarily be available without having to access other screens of ERP system application 30. As mentioned previously, the user can preselect which additional information about the general ledger account for the selected customer will be displayed in content display application interface 130E. The additional information about the selected customer may be read from ERP system 20. In an example embodiment, content display application interface 130E may include a link 602 that can launch an application in the ERP system for accessing even more information about the selected G/L account (e.g. account master data). The process of launching the parameterized ERP system application, which may be launched in a separate window on the display screen 80, is performed by the side panel application 40 in content system 50.

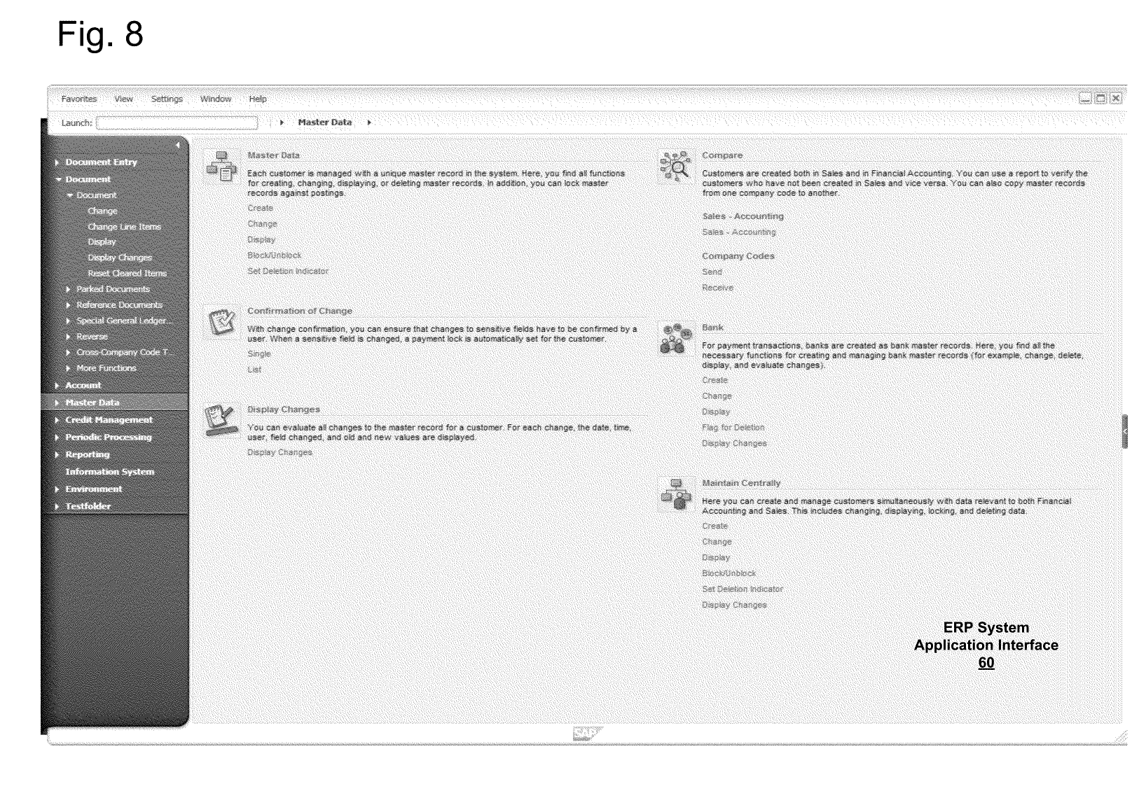

FIG. 8 shows a screenshot of an exemplary embodiment of an ERP system application interface 60 in which the user has selected the Master Data functionality (highlighted in the drop down list on the left hand side of the screenshot) for creating, changing, displaying or deleting master records in an ERP system application 30.

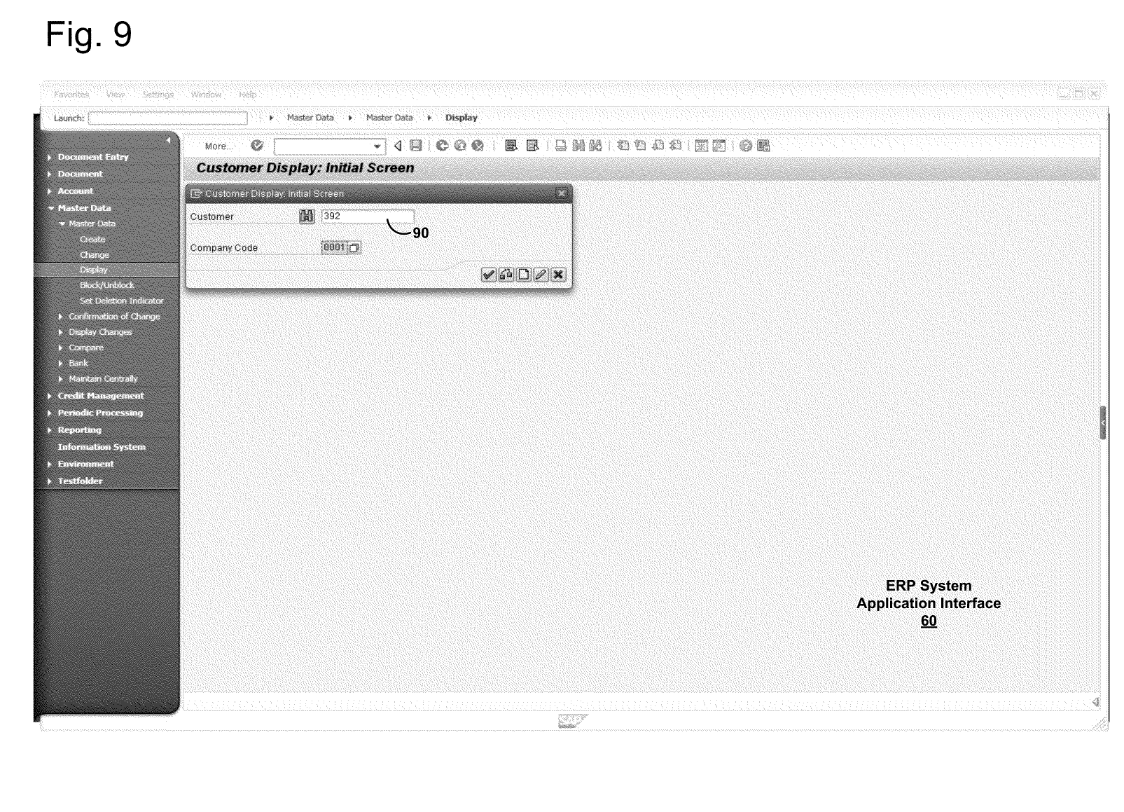

FIG. 9 shows another screenshot of an exemplary embodiment of an ERP system application interface 60 in which the user has selected the Display functionality (highlighted in the drop down list on the left hand side of the screenshot) for displaying master records in the ERP system application 30 and selected customer number 392 in the Customer field for viewing. In this example the Customer field of the ERP system application interface 60 is a tagged field 90, the contents of which are extracted to the side panel application.

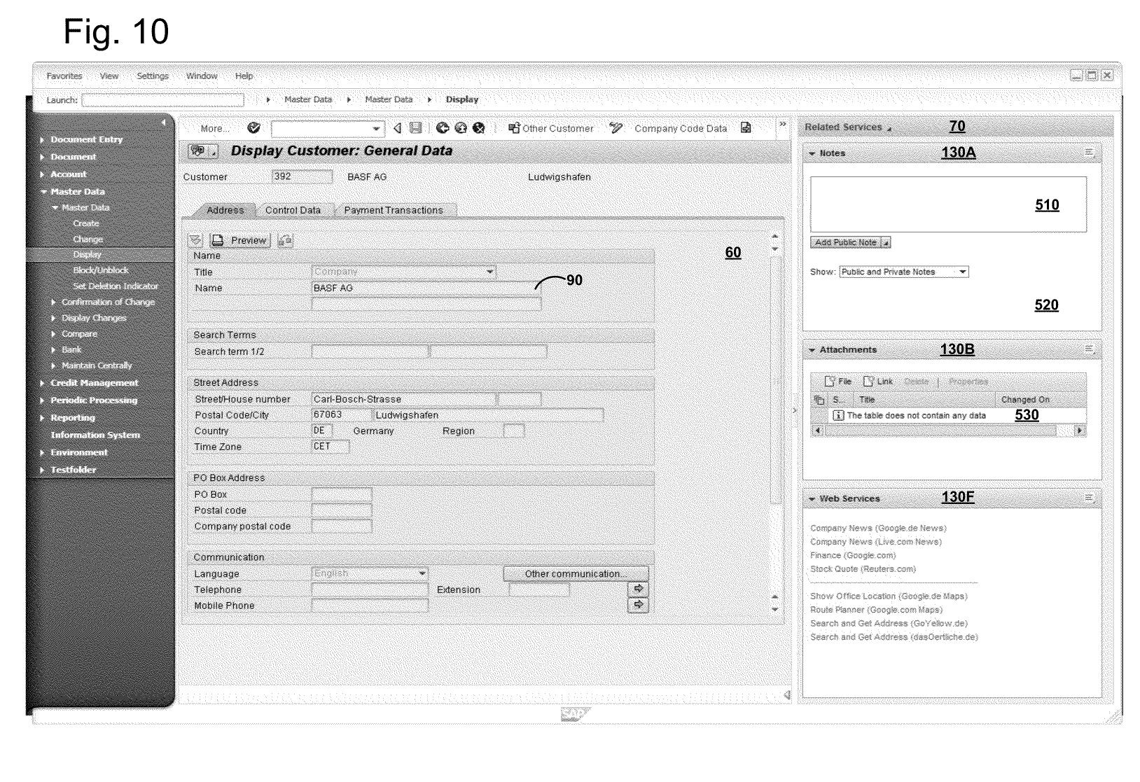

FIG. 10 shows a screenshot of an exemplary embodiment of an ERP system application interface 60 with information and functionality regarding customer number 392 being displayed in a side by side arrangement with an exemplary embodiment of a side panel application interface 70 for adding “Related Services” functionality to the ERP system application 30. As mentioned above, the Customer field of the ERP system application interface 60 is the tagged field 90, the contents of which are extracted to the side panel application. Also as explained above, in an example embodiment of the present invention the user may select which side panel application 40 will be running in conjunction with ERP system application 30 and the side panel application interface 70 shown side by side with the ERP system application interface 60 will correspond to this choice. The side panel application interface 70 includes several content display application interfaces 130A, 130B and 130F which correspond to respective content display applications 120 which may be included in a side panel application 40. As explained above, the content display applications 120 for the side panel application 40 may be built in such a way that they can react to unforeseen situations. In this example the user of the applications has navigated to a different screen of the existing ERP system application which does not have corresponding information for some of the content display applications 120 running in the side panel application 40. Therefore, field 520 of content display application interface 130A is blank because there are no associated notes and field 530 of content display application interface 130B indicates to the user that no data is available in the current context.

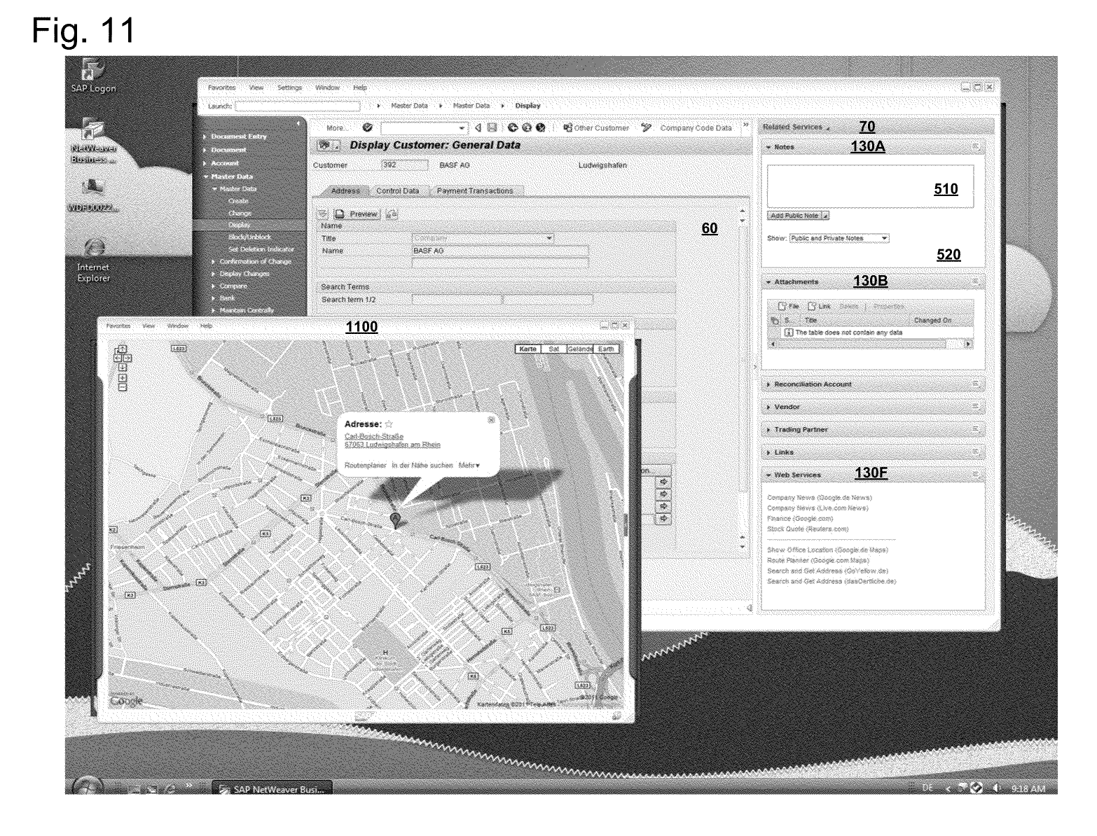

As explained above, in an example embodiment of the present invention the user may select which content display applications 120 will or will not be running in the side panel application 40 and the content display application interfaces 130 shown in the side panel application interface 70 will correspond to these choices. For example, content display application interface 130F corresponds to a content display application 120 for providing a “Web Services” functionality to ERP system application 30. Within content display application interface 130C the user is provided with functionality for launching web browsing applications parameterized with information related to the currently viewed customer. The applications may be stored in the content system. For example, links to “Google® Maps” are shown, in content display application interface 130F, that may be launched in order to view the office location for the currently viewed customer or plan a route to the office location from the users current location. The process of launching the parameterized application, which may be launched in a separate window on the display screen 80, is performed by the side panel application 40 in content system 50. FIG. 11 shows the user interface 1100 for the Google Maps application launched in a new window on the display screen 80. The Google Maps application is already displaying the office location for the customer being viewed in the ERP system application 30 without further input from the user.

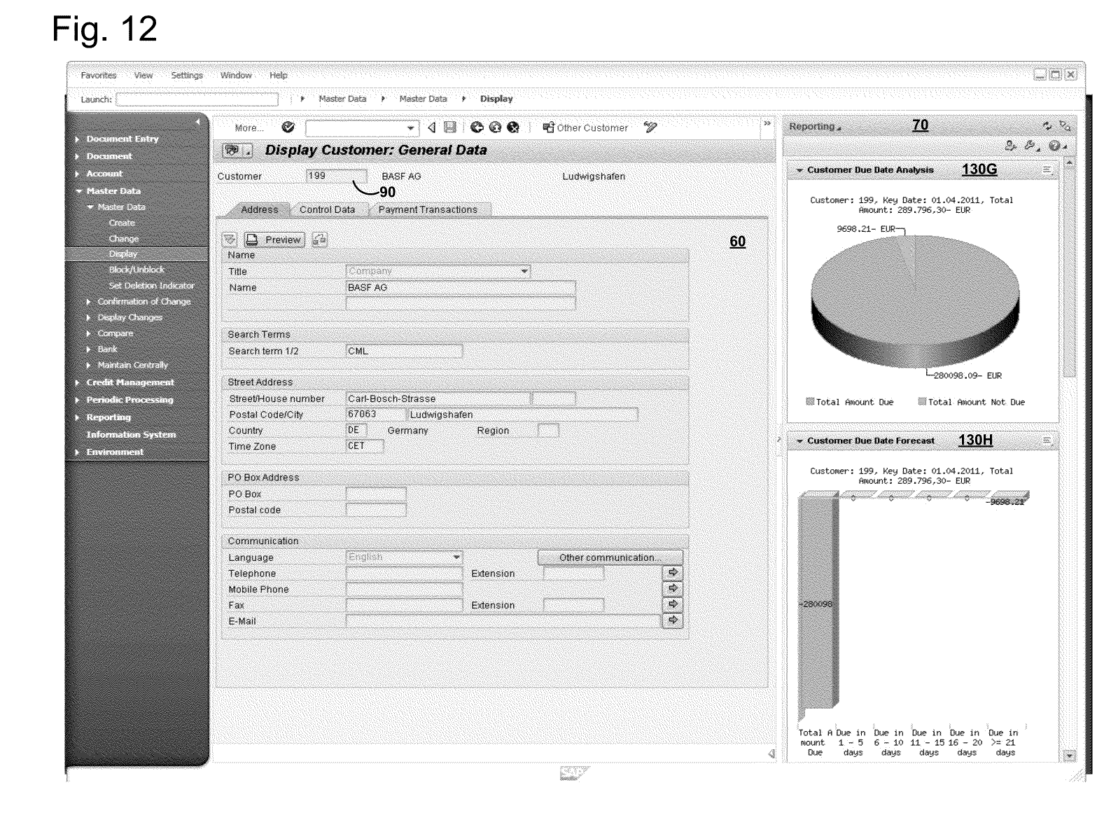

FIG. 12 shows another screenshot of an exemplary embodiment of an ERP system application interface 60 like that of FIG. 10, however in this example the information and functionality for customer number 199 is being displayed in a side by side arrangement with an exemplary embodiment of a side panel application interface 70 for adding a “Reports” functionality to the ERP system application 30. As in FIG. 10, the Customer field of the ERP system application interface 60 is the tagged field 90, the contents of which are extracted to the side panel application. Also as explained above, in an example embodiment of the present invention the user may select which side panel application 40 will be running in conjunction with ERP system application 30 and the side panel application interface 70 shown side by side with the ERP system application interface 60 will correspond to this choice. The side panel application interface 70 includes content display application interfaces 130G and 130H which correspond to respective content display applications 120 which may be running in the side panel application 40.

Content display application interface 130G corresponds to a content display application 120 for providing a “Customer Due Date Analysis” functionality to ERP system application 30. Within content display application interface 130G the user is provided with additional data in the form of a chart for analyzing due dates regarding the selected customer. This additional data would not ordinarily be available without having to access other screens of ERP system application 30. As mentioned previously, the user can preselect which additional information about the selected customer will be displayed in content display application interface 130G and can also specify the format of the presentation of the data, e.g. a pie cart in this example. The additional information about the selected customer may be read from ERP system 20.

Content display application interface 130H corresponds to a content display application 120 for providing a “Customer Due Date Forecast” functionality to ERP system application 30. Within content display application interface 130H the user is provided with additional data in the form of a graph for forecasting due dates for the selected customer. This additional data would not ordinarily be available without having to access other screens of ERP system application 30. As mentioned previously, the user can preselect which additional information about the selected customer will be displayed in content display application interface 130H and can also specify the format of the presentation of the data, e.g. a bar graph in this example. The additional information about the selected customer may be read from ERP system 20.

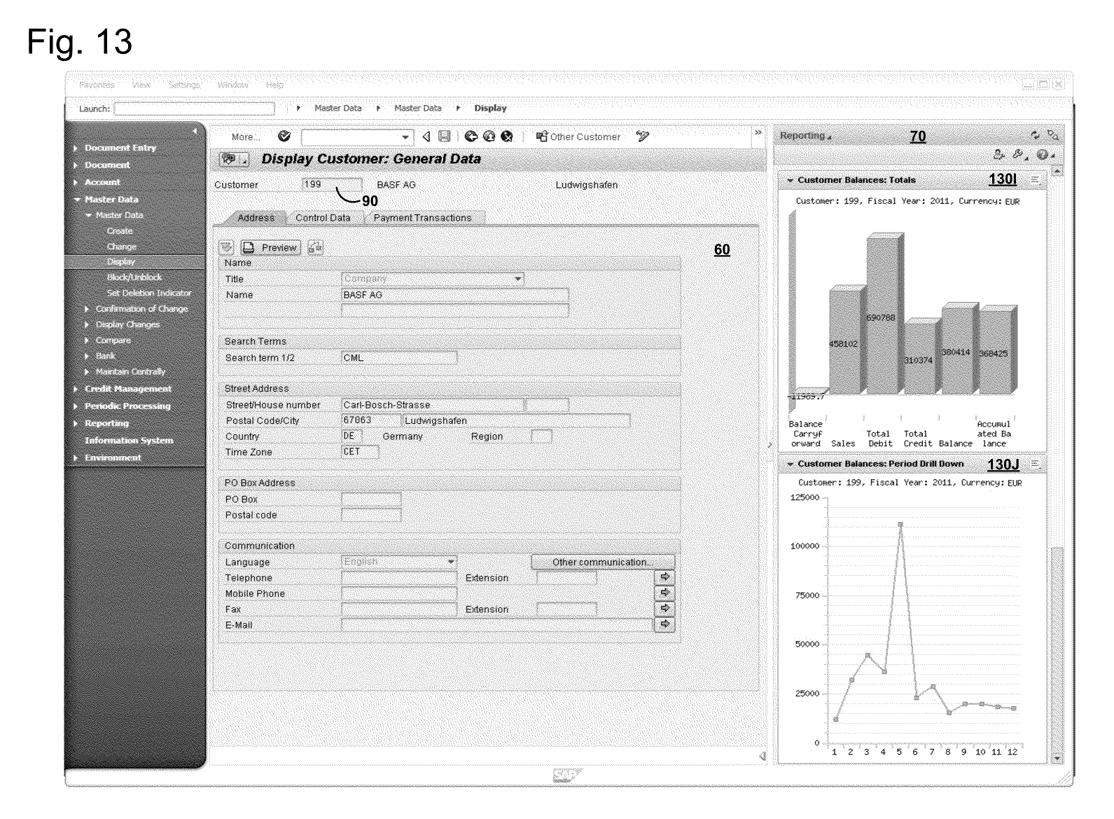

FIG. 13 shows another screenshot of an exemplary embodiment of an ERP system application interface 60 like that of FIG. 12, however in this example, the user has scrolled down the side panel application interface 70 for “Reports”, as indicated by the scroll bar on the right side of the screenshot, to display other content display application interfaces 130I and 130J which also correspond to respective content display applications 120 which may be running in the side panel application 40.

Content display application interface 1301 corresponds to a content display application 120 for providing a “Customer Balances: Totals” functionality to ERP system application 30. Within content display application interface 130I the user is provided with additional data in the form of a graph for analyzing balance totals for the selected customer. This additional data would not ordinarily be available without having to access other screens of ERP system application 30. As mentioned previously, the user can preselect which additional information about the selected customer will be displayed in content display application interface 130I and can also specify the format of the presentation of the data, e.g. a bar graph in this example. The additional information about the selected customer may read from ERP system 20.

Content display application interface 130J corresponds to a content display application 120 for providing a “Customer Balances: Period Drill Down” functionality to ERP system application 30. Within content display application interface 130J the user is provided with additional data in the form of a graph for analyzing period drill down balances for the selected customer. This additional data would not ordinarily be available without having to access other screens of ERP system application 30. As mentioned previously, the user can preselect which additional information about the selected customer will be displayed in content display application interface 130J and can also specify the format of the presentation of the data, e.g. a line graph in this example. The additional information about the selected customer may be read from ERP system 20.

As mentioned above, content display application interface 130C corresponds to a content display application 120 for providing a “Links” functionality to ERP system application 30. Within such a content display application interface the user is provided with functionality for launching other applications parameterized with information related to the currently running application in the existing system application. Because collaboration is relevant for many business processes, for example, planning and budgeting, month end closing, reorganization, etc., a link for launching a collaboration application (e.g. StreamWork) that communicates with co-workers electronically (e.g. e-mail) regarding information related to the currently running application may be implemented in the content display application interface.

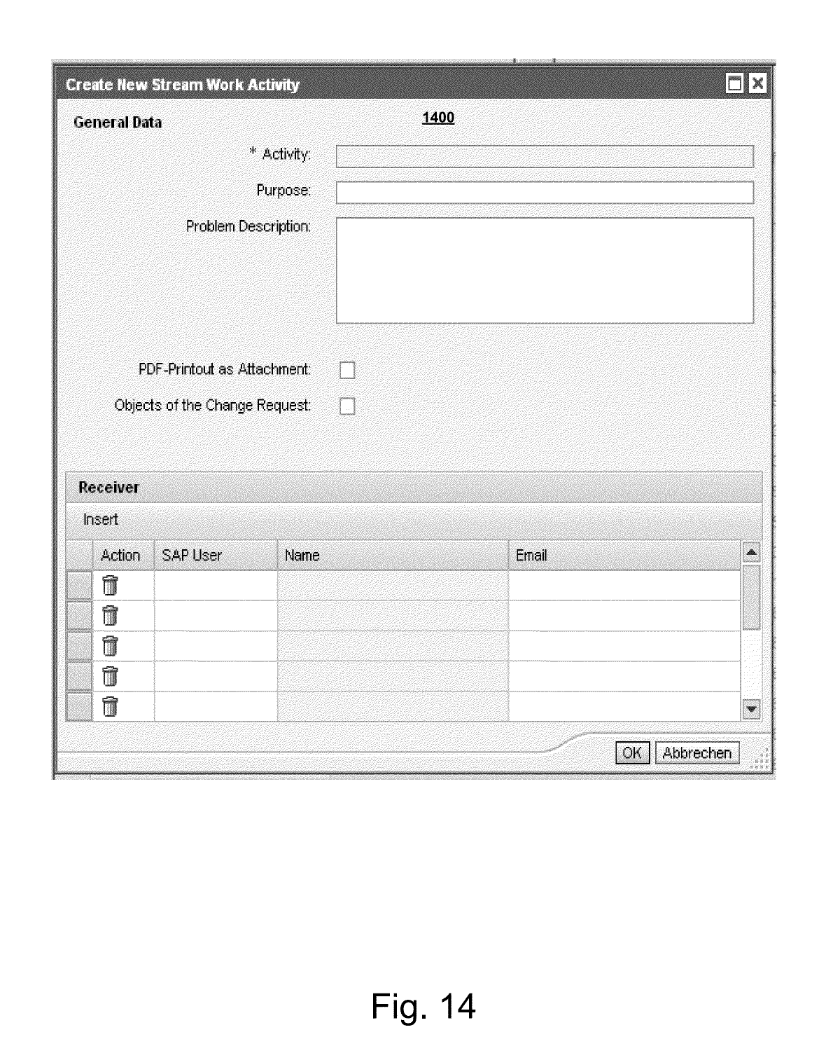

FIG. 14 shows an exemplary embodiment of a user interface 1400 for such a collaboration application launched in a new window on the display screen 80. The collaboration application includes functionality for creating a new collaboration activity and communicating by e-mail with co-workers regarding information related to the currently running application in the ERP system application 30.

Note that while embodiments of the present invention are described in the context of a fully functional computer system, those skilled in the art will appreciate that modules of the present invention are capable of being distributed in a variety of forms across a plurality of systems. Embodiments consistent with the invention may also include one or more programs or program modules on different computing systems running separately and independently of each other, while in their entirety being capable of performing business transactions in a large enterprise environment or in a “software on demand” environment. These programs or program modules may be contained on signal bearing media that may include: recordable type media such as floppy disks and CD ROMS, and transmission type media such as digital and analog communication links, including wireless communication links.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

1. A method for adding context sensitive extensions to existing system applications, comprising:
simultaneously displaying on a computer screen the respective user interfaces for an application of an existing system and a side panel application of a content system;
extracting contents from at least one on-screen field of the existing system application according to a database table in the content system; and
transferring the extracted contents to the side panel application;
wherein:
at least one user selectable content display application running within the side panel application reads additional content from the existing system based on the extracted contents; and
the at least one user selectable content display application displays at least one of the read contents in at least one content display application user interface within the side panel application user interface displayed on the computer screen.

2. The method of claim 1, wherein the at least one user selectable content display application displays additional data related to at least one of the extracted and read contents.

3. The method of claim 1, wherein the at least one user selectable content display application displays reports which include analysis of data related to at least one of the extracted and read contents.

4. The method of claim 1, further comprising:
using one of the at least one content display application user interface to create at least one object in the content system that is linked to at least one object in the existing system application.

5. The method of claim 4, wherein the at least one user selectable content display application displays at least one object in the content system or in the existing ERP system that is linked to at least one object in the existing system application.

6. The method of claim 1, wherein the at least one user selectable content display application displays at least one link for launching another application.

7. The method of claim 6, wherein the application launched via the at least one link receives information from the at least one user selectable content display application related to at least one of the extracted and read contents.

8. The method of claim 7, wherein the application launched via the at least one link is a web browsing application that accesses Web Services using the information received from the at least one user selectable content display application.

9. The method of claim 7, wherein the application launched via the at least one link is a collaboration application that communicates electronically with co-workers regarding the information received from the at least one user selectable content display application.

10. The method of claim 1, wherein the at least one user selectable content display application provides at least one of a) data related to at least one of the extracted and read contents as specified by the user, and b) functionality related to at least one of the extracted and read contents as specified by the user.

11. The method of claim 1, wherein the at least one user selectable content display application provides at least one of a) data related to at least one of the extracted and read contents in a format specified by the user, and b) functionality related to at least one of the extracted and read contents displayed in a format specified by the user.

12. The method of claim 1, wherein the existing ERP system and the content system are one system.

13. The method of claim 1, wherein the existing ERP system is not modified.

14. A computer-readable medium having stored thereon instructions adapted to be executed by a processor, the instructions which, when executed, cause the processor to perform a method for adding context sensitive extensions to existing system applications, comprising:
simultaneously displaying on a computer screen the respective user interfaces for an application of an existing system and a side panel application of a content system;
extracting contents from at least one on-screen field of the existing system application according to a database table in the content system; and
transferring the extracted contents to the side panel application;
wherein:
at least one user selectable content display application running within the side panel application reads additional content from the existing system based on the extracted contents; and
the at least one user selectable content display application displays at least one of the read contents in at least one content display application user interface within the side panel application user interface displayed on the computer screen.

15. A system for adding context sensitive extensions to existing system applications, comprising:
a display device including a computer screen; and
a processor configured to:
simultaneously display on the computer screen the respective user interfaces for an application of an existing system and a side panel application of a content system;
extract contents from at least one on-screen field of the existing system application according to a data base table in the content system; and
transfer the extracted contents to the side panel application;
wherein:
at least one user selectable content display application running within the side panel application reads additional content from the existing system based on the extracted contents; and
the at least one user selectable content display application displays at least one of the read contents in at least one content display application user interface within the side panel application user interface displayed on the computer screen.

16. The system of claim 15, wherein the at least one user selectable content display application displays additional data related to at least one of the extracted and read contents.

17. The system of claim 15, wherein the at least one user selectable content display application displays reports which include analysis of data related to at least one of the extracted and read contents.

18. The system of claim 15, wherein the at least one user selectable content display application displays at least one link for launching another application and the application launched via the at least one link receives information from the at least one user selectable content display application related to at least one of the extracted and read contents.

19. The system of claim 15, wherein the at least one user selectable content display application provides at least one of a) data related to at least one of the extracted and read contents as specified by the user, and b) functionality related to at least one of the extracted and read contents as specified by the user.

20. The system of claim 15, wherein the at least one user selectable content display application provides at least one of a) data related to at least one of the extracted and read contents in a format specified by the user, and b) functionality related to at least one of the extracted and read contents displayed in a format specified by the user.
